(19) United States
(12) Patent Application Publication
(10) Pub. No.: US 2021/0144024 A1
(43) Pub. Date: May 13, 2021

(54) DEVICE SERVICE CONTROL METHOD, CLOUD SERVER, AND SMART HOME SYSTEM

(71) Applicant: Huawei Technologies Co., Ltd., Shenzhen (CN)

(72) Inventor: Wei WANG, Shenzhen (CN)

(21) Appl. No.: 17/096,650

(22) Filed: Nov. 12, 2020

Related U.S. Application Data
(63) Continuation of application No. PCT/CN2020/081978, filed on Mar. 30, 2020.

(30) Foreign Application Priority Data
May 31, 2019 (CN) 201910470474.5

(51) Int. Cl. H04L 12/28; H04L 29/08

(52) U.S. Cl. CPC H04L 12/2809; H04L 67/02; H04L 12/2816; H04L 12/2823

(57) ABSTRACT

A method for controlling a device service includes: obtaining, by a cloud server, historical device service information from a plurality of smart home devices in a same scenario, where device service information in the historical device service information includes a service command and service attribute information; generating, by the cloud server, a scenario service file based on the historical device service information; obtaining, by the cloud server, scenario information of the scenario; and the cloud server sends the service command in the scenario service file to the plurality of smart home devices when the scenario information satisfies a preset condition, and the plurality of smart home devices execute a service based on the service command in the scenario service file. In this way, a plurality of services can be quickly enabled.

### CROSS-REFERENCE TO RELATED APPLICATIONS

This application is a continuation of International Patent Application No. PCT/CN2020/081978, filed on Mar. 30, 2020, which claims priority to Chinese Patent Application No. 201910470474.5, filed on May 31, 2019. The disclosures of the aforementioned applications are hereby incorporated by reference in their entireties.

### TECHNICAL FIELD

This application relates to the smart home field, and in particular, to a device service control method, a cloud server, and a smart home system.

### BACKGROUND

With the development of network technologies and computer technologies, intelligent devices are more diversified and have more powerful functions. How to control an intelligent device to bring convenience to life becomes a matter of concern.

In the prior art, a smart home device in each room is recorded in a system management application program in advance, and a user can view the smart home device in each room by using the system management application program. The user can send a command to a smart home device by using an application program of each device, so that the smart home device executes a corresponding service according to the command.

When the user needs to use a plurality of smart home devices, the user needs to separately use an application program of each device to control the smart home devices. More steps are required for switching between software. Therefore, it is inconvenient for the user to enable services of a plurality of smart home devices, and efficiency is comparatively low.

### SUMMARY

In view of this, this application provides a device service control method, a cloud server and a smart home system, which can simply and effectively control a plurality of devices, thus improving efficiency.

According to a first aspect of this application, a device service control method is provided, including: obtaining, by a cloud server, historical device service information of a plurality of smart home devices in a same scenario, and generating a scenario service file based on the historical device service information, where device service information in the historical device service information includes a service command and service attribute information, the service attribute information includes service execution moments, and device service information in the scenario service file is sorted based on the service execution moments; obtaining, by the cloud server, scenario information of the scenario; and sending, by the cloud server, the service command in the scenario service file to the plurality of smart home devices when the scenario information satisfies a preset condition, so that the plurality of smart home devices execute a service according to the service command in the scenario service file. The device service information in the scenario service file may be the same as the device service information in the historical device service information. Alternatively, the device service information in the scenario service file is obtained after the device service information in the historical device service information is processed.

The device service information includes the service command and the service attribute information. The service command is a control command related to a service. The service command may be but is not limited to enabling a service, disabling a service, suspending a service, or adjusting the service attribute information. The service attribute information includes one or more of a service execution moment, a service attribute value, service attribute content, or a service trigger rule. The service attribute value is a value used to describe a service attribute. The service attribute content includes but is not limited to text, a number, or a symbol used to describe a service attribute. The service trigger rule may be selected by a user from a preset rule library, or may be obtained by the cloud server by processing a historical service device using a machine learning method.

According to the foregoing method implementation, services of the plurality of smart home devices can be aggregated in the scenario service file based on the historical device service information, and various smart home devices in one scenario can be controlled through the scenario service file, so that the smart home devices provide corresponding services. Compared with the prior art in which device services need to be enabled by separately switching between a plurality of application programs, the device service control method in this application can automatically enable a plurality of services, thus implementing intelligent control and having the advantages of simplicity and convenience.

In a possible implementation, the generating, by the cloud server, a scenario service file based on the historical device service information includes: determining, by the cloud server, a recording period according to a recording start command and a recording stop command that are sent by a terminal at different moments; and generating, by the cloud server, the scenario service file based on historical device service information sent by the plurality of smart home devices in the recording period. According to the implementation, the cloud server may automatically generate the scenario service file based on device service information of the recording period, and the user does not need to manually edit the scenario service file. Therefore, the scenario service file can be simply and effectively recorded.

In another possible implementation, the generating, by the cloud server, a scenario service file based on historical device service information sent by the plurality of smart home devices in the recording period includes: determining, by the cloud server based on the identity of the first user, device service information of a first target service in the historical device service information sent in the recording period, where the first target service is a service executed by the first user in the recording period; and generating, by the cloud server, the scenario service file based on the device service information of the first target service. The device service information further includes the identity of the first user. According to the implementation, the scenario service file can be generated based on the service executed by the first user in the recording period, and therefore a scenario service file of the first user is obtained. Likewise, based on identity information of each user, a scenario service file of the user can be obtained, so that a personalized service can be provided.

In another possible implementation, the generating, by the cloud server, a scenario service file based on the historical device service information includes: collecting, by the cloud server, statistics on the historical device service information to obtain a quantity of service execution times and a service execution moment of each service; selecting, by the cloud server, device service information of a second target service from the historical device service information based on a statistical result, where the second target service is a service whose quantity of service execution times is not less than a preset quantity of times, and a difference between whose service execution moment and a preset service execution moment is not greater than preset duration in a statistical period; and generating, by the cloud server, the scenario service file based on the device service information of the second target service. According to the implementation, a scenario service file can be automatically generated based on a device function that is frequently used and used at a fixed time in a scenario. Therefore, another method for generating a scenario service file is provided, which improves solution implementation flexibility.

In another possible implementation, the generating, by the cloud server, a scenario service file based on the device service information of the second target service includes: determining, by the cloud server based on an identity of a first user, device service information of a third target service in the device service information of the second target service, where the third target service is a service that is in the second target service and is executed by the first user; and generating, by the cloud server, the scenario service file based on the device service information of the third target service. The device service information further includes the identity of the first user. According to the implementation, a scenario service file can be generated based on a device function that the first user habitually uses. Likewise, based on identity information of each user, a plurality of device functions habitually used by the user can be obtained. When scenario information satisfies a preset condition, the plurality of device functions are automatically executed based on a user habit, so that a personalized service can be provided.

In another possible implementation, the obtaining, by the cloud server, scenario information of the scenario includes: obtaining, by the cloud server, a command sent by a terminal; and the method further includes: determining, by the cloud server, that the scenario information satisfies the preset condition when the command sent by the terminal is a command used to execute the scenario service file. According to the implementation, a user can send a command to the cloud server by using a terminal, to trigger the cloud server to send a service command to a smart home device according to the scenario service file, so that the smart home device executes a service according to the service command.

In another possible implementation, the obtaining, by the cloud server, scenario information of the scenario includes: obtaining, by the cloud server, a scenario moment of the scenario; and the method further includes: determining, by the cloud server, that the scenario information satisfies the preset condition when the cloud server detects that the scenario moment is a preset scenario moment. According to the implementation, the cloud server can be triggered periodically to send a service command to a smart home device according to the scenario service file, so that the smart home device executes a service according to the service command.

In another possible implementation, the obtaining, by the cloud server, scenario information of the scenario includes: obtaining, by the cloud server, a service attribute value sent by the smart home device; and the method further includes: determining, by the cloud server, that the scenario information satisfies the preset condition when the cloud server detects that the service attribute value is within a preset attribute value range. According to the implementation, when the service attribute value is within the preset attribute value range, the cloud server can be triggered to send a service command to a smart home device according to the scenario service file, so that the smart home device performs a service step according to the service command.

In another possible implementation, after the generating, by the cloud server, a scenario service file based on the historical device service information, the method further includes: adding, by the cloud server, device service information to the scenario service file according to an add command sent by the terminal; or deleting, by the cloud server, device service information from the scenario service file according to a delete command sent by the terminal; or modifying, by the cloud server, device service information in the scenario service file according to a modify command sent by the terminal. According to the implementation, the scenario service file can be edited, which may be but is not limited to adding, deleting, and modifying the device service information. Alternatively, the service attribute information included in the device service information can be edited. For example, the service attribute value, the service attribute content, or the service trigger rule is edited.

In another possible implementation, after the generating, by the cloud server, a scenario service file based on the historical device service information, the method further includes: sending, by the cloud server, the scenario service file to the terminal, so that the scenario service file is displayed on a scenario page of the terminal; receiving, by the cloud server, a select command sent by the terminal; determining, by the cloud server, device service information of a fourth target service in the scenario service file according to the select command; and obtaining, by the cloud server, associated service information corresponding to the fourth target service, and sending the associated service information to the terminal, so that the associated service information is displayed on a scenario page of the terminal. According to the implementation, a user can select device service information of any service from the scenario service file by using the terminal, and the cloud server can recommend associated service information to the user. The user can enable, by using the terminal, an associated service corresponding to the associated service information.

In another possible implementation, after the generating, by the cloud server, a scenario service file based on the historical device service information, the method further includes: determining, by the cloud server, a first subscription service based on a scenario name in the scenario service file, and sending the first subscription service to the terminal; or determining, by the cloud server, a second subscription service based on the device service information in the scenario service file, and sending the second subscription service to the terminal. According to the implementation, a subscription service can be pushed based on a scenario name or device service information in a scenario. Alternatively, the cloud server can push related information based on a scenario name or device service information in a scenario.

In another possible implementation, the method further includes: receiving, by the cloud server, a share command sent by a first terminal, where the share command includes an identity of a second user and an internet protocol (IP) address of a second terminal, and the second terminal is a terminal used by the second user; determining, by the cloud server, permission of the second user based on the identity of the second user; determining, by the cloud server, device service information of a fifth target service in the scenario service file based on the permission of the second user; and sending, by the cloud server, the device service information of the fifth target service to the second terminal according to the IP address of the second terminal. According to the implementation, a device service in a scenario can be shared according to user permission, thus improving security of managing a device service in a scenario.

According to a second aspect of this application, a cloud server is provided and has a function of implementing the cloud server in any implementation of the first aspect. The function may be implemented by hardware, or may be implemented by hardware by executing corresponding software. The hardware or software includes one or more modules corresponding to the foregoing functions.

According to a third aspect of this application, a smart home system is provided and includes a plurality of smart home devices and a cloud server. The cloud server is the cloud serve in the second aspect.

According to a fourth aspect of this application, a computer readable storage medium is provided, where an instruction is stored in the computer readable storage medium. When the instruction runs on a computer, the computer is enabled to perform the method described in the first aspect or the implementations of the first aspect.

According to a fifth aspect of this application, a computer program product that includes an instruction is provided. When the computer program product runs on a computer, the computer is enabled to perform the method described in the first aspect or the implementations of the first aspect.

### BRIEF DESCRIPTION OF DRAWINGS

FIG. 1 is a schematic diagram of a smart home system according to this application;

FIG. 2 is a schematic diagram of a cloud server according to this application;

FIG. 3 is schematic flowchart of a device service control method according to this application;

FIG. 4A is a schematic diagram of creating a scenario service file according to this application;

FIG. 4B is another schematic diagram of creating a scenario service file according to this application;

FIG. 4C is a schematic diagram of executing a scenario service file according to this application;

FIG. 4D is another schematic diagram of executing a scenario service file according to this application;

FIG. 5A is another schematic diagram of creating a scenario service file according to this application;

FIG. 5B is another schematic diagram of creating a scenario service file according to this application; and

FIG. 6 is another schematic diagram of a cloud server according to this application.

### DESCRIPTION OF EMBODIMENTS

This application relates to a device service control method, and the method may be applied to a smart home system.

In the smart home system, various smart home devices (such as audio and video devices, a lighting device, a curtain, an air conditioner, a security protection system, an environment monitoring device, and a refrigerator) at home are connected by using the internet-of-things technology. The smart home system thus can provide a plurality of functions, such as audio and video control, lighting control, curtain control, air conditioner control, anti-theft alarming, environment monitoring, refrigerator control, and programmable timing control. Compared with a common household device, a smart home device has an information exchange function added, so that wired and/or wireless control can be implemented.

In this application, a smart home device is a household device with a computing function and a network function, for example, an audio device (such as a loudspeaker), a smart TV, a smart light, a smartphone, a smart surveillance camera, a smart curtain, a smart switch, a smart air conditioner, a smart water heater, a motion sensor, and a thermostat.

A cloud server and the smart home device are in a wired and/or wireless connection. A program module of a device service of the smart home device is deployed on the cloud server. The smart home device may be controlled, by using the program module, to execute a corresponding service. In this application, a device service is also referred to as a service. For example, a service corresponding to a motion sensor may include a movement status of a monitored object, a rest period, battery status monitoring of the motion sensor, and a start moment. A service corresponding to a thermostat may include current temperature monitoring and target temperature.

A terminal is an electronic device with a computing capability. The terminal may be a personal computer, a mobile phone, a tablet computer, an intelligent wearable device (such as a smartwatch or smart glasses), a personal digital assistant (PDA), or the like.

In an optional embodiment, a smart home system includes a smart home device and a cloud server.

The smart home device is configured to send the device service information to the cloud server, receive a service command that is in the scenario service file and that is sent by the cloud server, and execute a service according to the service command in the scenario service file.

The cloud server is configured to: obtain historical device service information of a plurality of smart home devices in a same scenario, where device service information in the historical device service information includes a service command and service attribute information; generate a scenario service file based on the historical device service information; obtain scenario information of the scenario; and send the service command in the scenario service file to the plurality of smart home devices when the scenario information satisfies a preset condition.

It should be noted that a user can log in to the smart home system by using a smart TV and the user can send an instruction to the smart home system by using the smart TV, so that another smart home device is managed by using the smart TV. Information exchange between the smart TV and the cloud server can implement all or part of the device service control method in this application.

In another optional embodiment, a smart home system includes a smart home device, a cloud server and a terminal.

FIG. 1 is a schematic diagram of a smart home system. Referring to FIG. 1, the smart home system includes a smart door 11, a smart light 12, a smart TV 13, a cloud server 14, and a terminal 15. The cloud server 14 is separately connected to the smart door 11, the smart light 12, the smart TV 13, and the terminal 15 by using a wired link or a wireless link.

Smart home devices (such as the smart door 11, the smart light 12, and the smart TV 13) may separately send device service information to the cloud server. The cloud server 14 obtains historical device service information of a plurality of smart home devices in a same scenario, where device service information in the historical device service information includes a service command and service attribute information, and the service attribute information includes a service execution moment. A scenario service file is generated based on the historical device service information, and device service information in the scenario service file is sorted based on the service execution moments. Scenario information of the scenario is obtained. The service command in the scenario service file is sent to the plurality of smart home devices when the scenario information satisfies a preset condition. The smart home devices (such as the smart door 11, the smart light 12, and the smart TV 13) receive the service command that is in the scenario service file and is sent by the cloud server, and execute a service according to the service command in the scenario service file. For example, after receiving an unlock command, the smart door 11 opens according to the unlock command. After receiving a turn-off command, the smart light 12 turns off according to the turn-off command. After receiving a pause command, the smart TV 13 suspends video playing.

The terminal 15 is configured to exchange information with the cloud server 14. The information may be but is not limited to an instruction, device data, service association data, or advertisement. A user may log in to the cloud server 14 by using the terminal 15, and then functions of smart home devices (such as the smart door 11, the smart light 12, and the smart TV 13) on the cloud server may be displayed on the terminal 15. Alternatively, the terminal 15 sends an instruction used to execute the scenario service file to the cloud server 14, so that the cloud server 14 sends a service command in the scenario service file to the smart home devices according to the instruction. The smart home devices (such as the smart door 11, the smart light 12, and the smart TV 13) execute a service according to the service command in the scenario service file. Alternatively, the terminal 15 receives and displays push information sent by the cloud server. The instruction is also referred to as a command, a computer instruction, or a computer command.

The cloud server 14 in this application may be implemented by using a server. FIG. 2 is a schematic structural diagram of a server according to an embodiment of this application. Referring to FIG. 2, a server 200 may vary significantly due to different configurations or performance. It may include one or more central processing units (CPU) 222, one or more memories 232, and one or more storage media 230 (e.g., one or more mass storage devices) that store an application program 242 or data 244. The memory 232 and the storage medium 230 may be temporary storage or persistent storage. The application program 242 stored in the storage medium 230 may include one or more modules (not shown in the figure), and each module may include a series of corresponding instruction operations on the server. Further, the central processing unit 222 may be configured to communicate with the storage medium 230, and perform, on the server 200, the series of instruction operations in the storage medium 230.

The server 200 may further include one or more power supplies 226, one or more wired or wireless network interfaces 250, one or more input/output interfaces 258, and/or one or more operating systems 241, for example, Windows Server™, Mac OS X™, Unix™, Linux™, or FreeBSD™.

In this application, steps performed by a cloud server in the following embodiment may be based on the server structure shown in FIG. 2.

Referring to FIG. 3, an embodiment of the device service control method provided in this application includes the following steps.

Step 301: A cloud server obtains historical device service information of a plurality of smart home devices in a same scenario, where device service information in the historical device service information includes a service command and service attribute information.

A service attribute is a key indicator for describing a service. The service attribute information may include one or more of a service execution moment, a service attribute value, service attribute content, or a service trigger rule. The service attribute value is a value used to describe a service attribute. The service attribute content includes but is not limited to text, a number, or a symbol used to describe a service attribute. A service attribute of a lighting service may include one or more of brightness, a color, temperature, or lighting duration. A service attribute of a music service may include one or more of a music name, music playback progress, or playback duration. The service trigger rule is a condition for triggering a service. The service trigger rule may be but is not limited to being preset in a smart home system, or being set by a user, or being obtained by processing the historical device service information according to a machine learning method.

The service command is a control command related to a service. The service command may be but is not limited to enabling a service, disabling a service, suspending a service, or adjusting the service attribute information. In addition, the device service information may further include a service event. The service event is a predefined event reported by a device due to an environment change in the foregoing scenario, for example, an exception alarm.

It should be noted that device service information sent by a smart home device may include a scenario identifier, and the cloud server may distinguish between device service information of different scenarios based on the scenario identifier.

Step 302: The cloud server generates a scenario service file based on the historical device service information.

The cloud server may generate device service information in the scenario service file based on the service command and all or part of the service attribute information. The device service information in the scenario service file is sorted based on the service execution moment. It should be noted that the device service information in the scenario service file may be displayed on a scenario page, which facilitates user viewing or editing.

Step 303: The cloud server obtains scenario information of the scenario.

The scenario information may be but is not limited to a command sent by a terminal, a scenario moment, or service attribute information sent by a smart home device.

Step 304: The cloud server sends the service command in the scenario service file to the plurality of smart home devices when the scenario information satisfies a preset condition, so that the plurality of smart home devices execute a service according to the service command in the scenario service file.

The cloud server may send a service command to a corresponding smart home device based on a service execution moment, so that the plurality of smart home devices may execute a service according to the service command. From a user perspective, the plurality of smart home devices execute a service in a sequence preset in the scenario service file, so that a user requirement for quickly controlling a plurality of services can be met. It may be understood that the cloud server may also send a command including an execution moment to a smart home device, so that the smart home device can execute a service at the execution moment.

In this embodiment, services of the plurality of smart home devices can be aggregated in the scenario service file based on the historical device service information, and various smart home devices in one scenario can be controlled through the scenario service file, so that the smart home devices provide corresponding services. Compared with the prior art in which device services need to be enabled by separately switching between a plurality of application programs, the device service control method in this application can automatically enable a plurality of services, having the advantages of simplicity and convenience.

In an optional embodiment, the generating, by the cloud server, a scenario service file based on the historical device service information includes: determining, by the cloud server, a recording period according to a recording start command and a recording stop command that are sent by a terminal at different moments; and generating, by the cloud server, the scenario service file based on historical device service information sent by the plurality of smart home devices in the recording period.

In this embodiment, a user can set a recording period by using a terminal, the cloud server automatically generates a scenario service file based on device service information of the recording period, and the user does not need to manually edit the scenario service file. Therefore, the scenario service file can be simply and effectively recorded.

The following describes the device service control method in this application by using a specific application scenario. FIG. 4A is a schematic diagram of creating a scenario service file by using a terminal. Referring to FIG. 4A, an interface for creating a scenario service file includes an interface name (e.g., Creation Scenario), a save button, and a button 405. The button 405 is used to send a recording start command.

After a user presses the button 405, the terminal sends the recording start command to the cloud server. A scenario service file of a sleep scenario is used as an example. The user separately turns off a room light, plays a lullaby by using an audio device, and turns on a breathing light in a room. The room light, the audio device, and the breathing light may send device service information (such as a service command and service attribute information) to the cloud server.

The following uses an example in which the service attribute information includes a service execution moment and service attribute content. A user operation, a service command, and the service attribute information may be shown in Table 1.

TABLE 1

| | | Service | Service |
|---|---|---|---|
| | Service | execution | attribute |
| User operation | command | moment | content |
| Turn off a room light | Turn off | 23:00 | Room light |
| Play a lullaby by using an | Play | 23:01 | Lullaby |
| audio device | | | |
| Turn on a breathing light | Turn on | 23:02 | Breathing light |

The cloud server may generate a scenario service file based on the service commands and the service attribute information in Table 1. Device service information in the scenario service file may include a service execution sequence number, a service icon, service attribute content, a service command, and the like. The service execution sequence number may be determined by the cloud server based on a service execution moment. The service icon may be determined by the cloud server according to service attribute content.

The cloud server sends the scenario service file to the terminal. Information of the scenario service file is displayed on the interface for creating a scenario service file on the terminal. For example, for turning off a room light, the terminal may display: an execution sequence number 401 for a service of turning off a room light, an icon 402 for the service of turning off a room light, service attribute content 403 (e.g., a room light), and a service command 404 (e.g., a turn-off command). Likewise, the terminal may also display: an execution sequence number for a service of playing a lullaby, an icon for the service of playing a lullaby, service attribute content (such as a lullaby), and a service command (such as a play command); and an execution sequence number for a service of turning on a breathing light, an icon for the service of turning on a breathing light, service attribute content (such as a breathing light), and a service command (such as a turn-on command).

FIG. 4B is another schematic diagram of creating a scenario service file by using a terminal. After the user presses the button 405, the terminal may display a button 409, where the button 409 is used to send a recording stop command. After the user presses the button 409, the terminal sends the recording stop command to the cloud server. A scenario service file obtained by recording in this way may include device service information shown in FIG. 4B. On an interface for creating a scenario service file, a delete button 406, a move-up button 407, and a move-down button 408 may be provided for each piece of device service information. When the user presses the delete button 406, corresponding device service information may be deleted. When the user presses the move-up button 407, service execution corresponding to device service information may be adjusted forward in a sequence. When the user presses the move-down button 408, service execution corresponding to device service information may be adjusted backward in a sequence. In addition, the user may also edit service attribute information and a service trigger rule in the device service information, for example, adding, modifying, or deleting.

It should be noted that the terminal may display the button 405 again after the user presses the button 409, so that the user may continue to record a scenario. With the button 405 and the button 409 displayed alternately, the user may start recording and stop recording as required, thus controlling a recording process.

FIG. 4C and FIG. 4D are schematic diagrams of executing a scenario service file by using a terminal. Referring to FIG. 4C, for a created scenario service file of a sleep scenario, a display interface of the scenario service file includes a scenario service file name (e.g., Sleep Scenario) 410, a button 411, device service information of a room light, device service information of an audio device, and device service information of a breathing light. The button 411 is used to send a command for executing a scenario service file.

The device service information of the room light includes an icon 402 for a service of turning off the room light, service attribute content (such as the room light) 403 and a turn-off command 404. The device service information of the audio device includes an icon for a service of playing a lullaby, service attribute content (such as the lullaby), a play command, and the like. The device service information of the breathing light includes an icon for a service of turning on the breathing light, service attribute content (such as the breathing light), and a turn-on command.

When the user presses the button 411, the terminal sends the command for executing a scenario service file to the cloud server. The cloud server successively sends a service command to the room light, the audio device, and the breathing light according to the command, to implement the services of turning off the room light, playing the lullaby, and turning on the breathing light. Referring to FIG. 4D, on an interface for executing a scenario service file, the terminal may further display a current status of each service. For example, a playback progress bar 412 is displayed around the icon for the service of playing the lullaby, and the playback progress bar 412 is used to indicate playback progress of the lullaby. After the user presses the button 411, the terminal may display a button 413 on an interface for executing a scenario service file. After the user presses the button 413, the terminal sends a suspend command to the cloud server. The cloud server and a smart home device suspend, according to the suspend command, execution of a service corresponding to the scenario service file.

In actual application, a user A operates a device A, and a user B operates a device B in a recording period. In this case, an operation performed by the user A on the device A and an operation performed by the user B on the device B are both recorded in the recording period. When the user A is at home and the user B is not at home, and the user A does not need to use the device B, a scenario service file generated based on device service information in the recording period includes device service information of the device B, and thus is not suitable for the user A's requirement. Therefore, a personalized scenario service file may alternatively be set for a user in this application. Details are as follows:

In another optional embodiment, the device service information further includes an identity of a first user.

The generating, by the cloud server, a scenario service file based on historical device service information sent by the plurality of smart home devices in the recording period includes: determining, by the cloud server based on the identity of the first user, device service information of a first target service in the historical device service information sent in the recording period, where the first target service is a service executed by the first user in the recording period; and generating, by the cloud server, the scenario service file based on the device service information of the first target service.

In this embodiment, a user identity may be a user fingerprint, a user voiceprint, a user gait, a user head image, or the like.

The cloud server may determine, based on the identity of the first user, the device service information of the service executed by the first user in the recording period, and generate the scenario service file based on the device service information. A smart home device can automatically execute, according to a service command in the scenario service file, a device service required by the first user. Therefore, a personalized requirement of the first user can be met. Likewise, a corresponding scenario service file can be generated based on an identity of each user, so that a personalized service can be provided.

In another optional embodiment, the generating, by the cloud server, a scenario service file based on the historical device service information includes: collecting, by the cloud server, statistics on the historical device service information to obtain a quantity of service execution times and a service execution moment of each service; selecting, by the cloud server, device service information of a second target service from the historical device service information based on a statistical result, where the second target service is a service whose quantity of service execution times is not less than a preset quantity of times, and a difference between whose service execution moment and a preset service execution moment is not greater than preset duration in a statistical period; and generating, by the cloud server, the scenario service file based on the device service information of the second target service.

In this embodiment, in the historical device service information, the quantity of service execution times is determined based on a quantity of times that device service information appears. Statistics need to be collected separately for different services. Using a lighting service as an example, turning on a light and turning off a light are two services, and statistics need to be separately collected on a quantity of turn-on times and a quantity of turn-off times.

The preset service execution moment may be any service execution moment in the historical device service information. Alternatively, the preset service execution moment may be set by a user based on historical experience. Alternatively, the preset service execution moment may be an intermediate value determined by the cloud server based on service execution moments in the historical device service information, and may be but is not limited to an arithmetic average value or a weighted average value.

Device service information of each service in the statistical period may include one or more records. For a plurality of records, service commands are the same, and service execution moments of a plurality of services may be the same, or may be different. For each service of the second target service, one piece of service attribute information may be selected from a plurality of pieces of service attribute information, and the selected service attribute information and the foregoing service command are used as device service information in the scenario service file.

The cloud server may automatically generate a scenario service file based on a device function that is frequently used and used at a fixed time in a scenario, and then a smart home device executes a corresponding service according to a service command in the scenario service file. Therefore, a method for generating another scenario service file is provided, which improves solution implementation flexibility.

For example, a statistical period is 30 days, and the cloud server collects statistics on a quantity of times that a living room light is turned off, and a turn-off moment. Within 30 days, the living room light is turned off 20 times from 22:50:00 to 23:10:00, and the living room light is turned off 10 times after 12:00:00. A preset moment is 23:00:00, preset duration is 10 minutes, and a preset quantity of times is 15. Because the quantity of times that the living room light is turned off from 22:50:00 to 23:10:00 is greater than 15, the cloud server may determine that a service corresponding to one piece of device service information thereof (e.g., turning off the living room light at 23:00:00) is used as the second target service. The cloud server uses service attribute content (e.g., the living room light) and a service command (e.g., a turn-off command) as the device service information in the scenario service file. A service execution moment of the service is 23:00:00.

The following describes the device service control method in this application by using another application scenario.

A statistical period of one week is used as an example. In the statistical period, a user returns home at about 19:00 every day, unlocks a smart door, turns on an aisle light after entry, closes and locks the door, goes to a living room, turns on a living room light, goes back to turn off the aisle light, then goes to the living room, and turns on a smart air conditioner and a smart TV. In this scenario, a time difference between a moment at which the user opens the smart door, turns on the aisle light, closes and locks the door, turns on the living room light, turns off the aisle light, or turns on the smart air conditioner and the smart TV every day and a preset service execution moment of each service is not greater than preset duration.

After obtaining the foregoing device service information from the foregoing devices, the cloud server may determine that the foregoing device service information is the device service information of the second target service, and then generates a scenario service file based on the service execution moments. In this way, the cloud server can automatically generate a scenario service file based on historical device service information and a preset policy, and then push the scenario service file to a user.

Referring to FIG. 5A, an interface for creating a scenario service file includes creation interface prompt information 501 (e.g., “Do you need this scenario?”), a scenario period 502 (e.g., 19:00-20:00 every day), a service execution sequence number 503 (such as numbers 1, 2, 3, 4 and 5), service attribute content 505 (such as a door, an aisle light, and a living room light), a service command 506 (such as unlock, turn on, lock, and turn off), a button 507, and a button 508. The button 507 is used to complete creation of a scenario service file. The button 508 is a cancel button and is used to cancel creation of a scenario service file.

After a user presses the button 507, a created scenario service file is shown in FIG. 5B. Referring to FIG. 5B, a display interface of the scenario service file includes a scenario name (e.g., “Back Home Scenario”), the scenario period 502, a service icon 504 (such as a smart door icon, an aisle light icon, and a living room light icon), the service attribute content 505 (such as a door, an aisle light, and a living room light), and the service command 506 (such as unlock, turn on, lock, and turn off). The user may further set a scenario trigger condition for the scenario service file, so that the scenario service file may be executed. For example, when a fingerprint detection device on a smart door detects a preset user fingerprint, the fingerprint detection device sends the user fingerprint to the cloud server. The cloud server determines that the user fingerprint successfully matches the preset user fingerprint, and the cloud server sends a service command to the foregoing smart home devices (e.g., the door, the aisle light, and the living room light) based on the foregoing scenario service file, so that the foregoing smart home devices sequentially execute a service.

It should be noted that the cloud server may alternatively process the historical device service information according to a machine learning method, to obtain the device service information of the second target service; and the cloud server generates the scenario service file based on the device service information of the second target service. For the second target service, refer to the foregoing second target service. The machine learning method may be but is not limited to a neural network algorithm.

In another optional embodiment, the device service information further includes an identity of a first user.

The generating, by the cloud server, a scenario service file based on the device service information of the second target service includes: determining, by the cloud server based on the identity of the first user, device service information of a third target service in the device service information of the second target service, where the third target service is a service that is in the second target service and is executed by the first user; and generating, by the cloud server, the scenario service file based on the device service information of the third target service.

In this embodiment, the cloud server may generate the scenario service file based on a device service habitually used by the first user. Likewise, the cloud server may obtain, based on identity information of each user, a plurality of device services habitually used by the user, and therefore generates a personalized scenario service file. When a plurality of smart home devices execute a plurality of device functions based on a service command in each scenario service file, a service use habit of each user can be met, thus providing a personalized service for the user.

It should be noted that alternatively, image data of a user in a scenario may be collected by using a camera, and the collected image data is processed according to a machine learning method, to obtain the device service information of the third target service; and then the scenario service file is generated based on the device service information of the third target service.

In this application, a preset condition used to trigger scenario service file execution may be set based on an actual requirement, or may be obtained by the cloud server by processing the historical device service information by using a machine learning method. This is not limited herein. The following describes the preset condition by using an embodiment.

In an optional embodiment, the obtaining, by the cloud server, scenario information of the scenario includes: obtaining, by the cloud server, a command sent by a terminal.

The foregoing method further includes: determining, by the cloud server, that the scenario information satisfies the preset condition when the command sent by the terminal is a command used to execute the scenario service file.

In this embodiment, a user can enter, in a manner such as a button pressing operation, a voice instruction, or a gesture, a command used to execute the scenario service file. When the terminal sends the command used to execute the scenario service file, the cloud server may send a service command to a smart home device based on the scenario service file, so that the smart home device executes a service according to the service command. In this way, the user can use the terminal to enable services of a plurality of smart home devices. The user can enable the services of the plurality of smart home devices by performing only one operation or a few operations. Therefore, the services of the plurality of smart home devices can be quickly and effectively controlled.

In another optional embodiment, the obtaining, by the cloud server, scenario information of the scenario includes: obtaining, by the cloud server, a scenario moment of the scenario.

The foregoing method further includes: determining, by the cloud server, that the scenario information satisfies the preset condition when the cloud server detects that the scenario moment is a preset scenario moment.

In this embodiment, the preset scenario moment is a moment used to trigger scenario service file execution. The preset scenario moment may be set by a user based on an actual requirement, and is not limited. For example, at 7:00 am. every day, the cloud server sends a service command to a plurality of smart home devices based on the scenario service file, and the plurality of smart home devices execute a service according to the service command. In this way, a plurality of services can be executed at a fixed time, and a user does not need to manually perform an operation.

In another optional embodiment, the obtaining, by the cloud server, scenario information of the scenario includes: obtaining, by the cloud server, a service attribute value sent by the smart home device.

The foregoing method further includes: determining, by the cloud server, that the scenario information satisfies the preset condition when the cloud server detects that the service attribute value is within a preset attribute value range.

In this embodiment, the scenario information is the service attribute value sent by the smart home device. It should be noted that the smart home device that sends the scenario information may be a smart home device that provides a device service in the scenario service file, or may be another smart home device in the scenario.

Alternatively, the scenario information is service attribute content sent by the smart home device. When the cloud server detects that the service attribute content sent by the smart home device successfully matches preset service attribute content, the cloud server determines that the scenario information satisfies the preset condition.

For example, an intelligent door lock and a camera device are disposed on a smart door. The intelligent door lock provides an unlock function, and the unlock function is a device service in a scenario service file. The camera device may collect a face image, but face image collection is not a device service in the scenario service file. When the intelligent door lock detects that a fingerprint input by a user is a preset fingerprint, the cloud server determines that the scenario information satisfies the preset condition. Alternatively, when the camera device detects that a face image is a preset user image, the cloud server determines that the scenario information satisfies the preset condition.

In another optional embodiment, the obtaining, by the cloud server, scenario information of the scenario includes: obtaining, by the cloud server, a service event sent by a smart home device.

The method further includes: determining, by the cloud server, that the scenario information satisfies the preset condition when the cloud server detects that the service event is a preset event.

In this embodiment, the preset event is an event used to trigger scenario service file execution. The preset event may be set by a user based on an actual requirement, and is not limited. For example, the preset event is a door opening event. When a user opens a smart door, the smart door reports the door opening event. The cloud server determines, based on the door opening event, that the scenario information satisfies the preset condition.

It may be understood that the scenario information may include a plurality of service events, and there may be a plurality of preset events. When there are a plurality of preset events, and each service event matches a corresponding preset event, the cloud server determines that the scenario information satisfies the preset condition.

It can be learned that the foregoing method enables a smart home device to execute a service according to a service command in a scenario service file, and a user does not need to manually perform an operation.

In actual application, a scenario service file generated by a cloud server may include device service information that does not meet a user requirement, or may lack device service information that satisfies a user requirement. Therefore, this application provides a method for editing a scenario service file, so that a scenario service file can be edited, and thus a scenario service file that satisfies a user requirement is obtained.

In another optional embodiment, after the generating, by the cloud server, a scenario service file based on the historical device service information, the method further includes: adding, by the cloud server, device service information to the scenario service file according to an add command sent by the terminal; or deleting, by the cloud server, device service information from the scenario service file according to a delete command sent by the terminal; or modifying, by the cloud server, device service information in the scenario service file according to a modify command sent by the terminal.

In this embodiment, editing the scenario service file may be but is not limited to adding, deleting, or modifying the device service information, or may be editing service attribute information included in the device service information. For example, a service attribute value, service attribute content, or a service trigger rule is edited. In this way, a user can edit the scenario service file, and thus a scenario service file that satisfies a requirement is obtained.

In another optional embodiment, after the generating, by the cloud server, a scenario service file based on the historical device service information, the foregoing method further includes: sending, by the cloud server, the scenario service file to the terminal, so that the scenario service file is displayed on a scenario page of the terminal; receiving, by the cloud server, a select command sent by the terminal; determining, by the cloud server according to the select command, device service information of a fourth target service in the scenario service file; and obtaining, by the cloud server, associated service information corresponding to the fourth target service, and sending the associated service information to the terminal, so that the associated service information is displayed on a scenario interface of the terminal.

In this embodiment, the terminal may display device service information of the scenario service file on the scenario page. Part of each piece of device service information may be displayed. For example, a service command, a service identifier, a service execution sequence number, and status information of a service device are displayed on the scenario page.

The cloud server may push associated service information based on device service information selected by a user. A service corresponding to the associated service information may be but is not limited to a service provided by a smart home device or the terminal. For example, in a scenario service file of guest visiting, a location sharing service of social software is set as the associated service information, and a home address is provided for a visitor. In a scenario service file of a family scenario, a message board function is set as the associated service information, and a message is sent to a family member.

The associated service information may be displayed on the scenario page, or may be displayed in another manner, for example, in a pop-up window, or may be displayed in an application program of the associated service information, so that the user may view the associated service information.

In another optional embodiment, after the generating, by the cloud server, a scenario service file based on the historical device service information, the method further includes: determining, by the cloud server, a first subscription service based on a scenario name in the scenario service file, and sending the first subscription service to the terminal; or determining, by the cloud server, a second subscription service based on the device service information in the scenario service file, and sending the second subscription service to the terminal.

In this embodiment, a subscription service may be pushed based on the scenario name and/or the device service information in the scenario service file. The subscription service may be pushed based on a keyword in the scenario name and/or the device service information.

For example, a scenario name in a scenario service file is “Baby Care”, and one piece of device service information included in the scenario service file is “Detecting sleep duration”. The cloud server obtains keywords “Baby”, “Care”, and “sleep”, obtains subscription services such as “Common Knowledge About Baby Sleep” and “Baby Care Institution” from a subscription server, and then pushes the subscription services to the terminal. A user may purchase the foregoing subscription services and thus obtain related information.

In another optional embodiment, the foregoing method further includes: receiving, by the cloud server, a share command sent by a first terminal, where the share command includes an identity of a second user and an internet protocol (IP) of a second terminal, and the second terminal is a terminal used by the second user; determining, by the cloud server, permission of the second user according to the identity of the second user; determining, by the cloud server based on the permission of the second user, device service information of a fifth target service in the scenario service file; and sending, by the cloud server, the device service information of the fifth target service to the second terminal according to the IP address of the second terminal.

In this embodiment, the fifth target service is a service that is among services corresponding to the scenario service file and on which the second user has access or control permission. The services corresponding to the scenario service file are services corresponding to a plurality of pieces of device service information in the scenario service file.

The first terminal may be a terminal used by a family member in a scenario. After the first terminal sends the share command, the cloud server may determine the device service information of the fifth target service in the scenario service file based on the permission of the second user, and sends the device service information of the fifth target service to the second terminal. Alternatively, after determining the device service information of the fifth target service, the cloud server generates a new scenario service file based on the device service information of the fifth target service, and sends the new scenario service file to the second terminal.

Alternatively, the cloud server adjusts read/write permission settings of device service information except the device service information of the fifth target service in the scenario service file to be unreadable, or unreadable and not writable. In this case, after the second user sends a command to the cloud server by using the second terminal, the cloud server may send a service command to a smart home device based on the device service information of the fifth target service, and the smart home device executes a service according to the service command. The second user can use only the fifth target service, and is not allowed to use another service among the services corresponding to the scenario service file. In this way, a device service in a scenario can be shared according to user permission, thus improving security of device service management.

It should be noted that the second terminal may obtain the device service information of the fifth target service by using an applet or a page application when no application program of a smart home system is installed on the second terminal.

The foregoing describes the device service control method in this application. The following describes a cloud server in this application. The cloud server in this application can implement functions performed by the cloud server in the embodiment shown in FIG. 3 or the optional embodiments.

Referring to FIG. 6, an embodiment of a cloud server in this application includes:

a first obtaining module 601, configured to obtain historical device service information of a plurality of smart home devices in a same scenario, where device service information in the historical device service information includes a service command and service attribute information, and the service attribute information includes service execution moments;

a processing module 602, configured to generate a scenario service file based on the historical device service information, and sort device service information in the scenario service file based on the service execution moments;

a second obtaining module 603, configured to obtain scenario information of the scenario; and
a sending module 604, configured to: send the service command in the scenario service file to the plurality of smart home devices when the scenario information satisfies a preset condition, so that the plurality of smart home devices execute a service according to the service command in the scenario service file.

It should be noted that, in some embodiments, the processing module 602 may be further connected to the sending module 604.

In an optional embodiment, the processing module 602 includes a determining unit and a first generation unit.

The determining unit is configured to determine a recording period according to a recording start command and a recording stop command that are sent by a terminal at different moments; and the first generation unit is configured to generate the scenario service file based on historical device service information sent by the plurality of smart home devices in the recording period.

In another optional embodiment, the device service information further includes an identity of a first user.

The first generation unit is configured to determine, based on the identity of the first user, device service information of a first target service in the historical device service information sent in the recording period, where the first target service is a service executed by the first user in the recording period; and generate the scenario service file based on the device service information of the first target service.

In another optional embodiment, the processing module 602 includes a statistics collection unit, a selection unit, and a second generation unit.

The statistics collecting unit is configured to collect statistics on the historical device service information to obtain a quantity of service execution times and a service execution moment of each service.

The selection unit is configured to select, device service information of a second target service from the historical device service information based on a statistical result, where the second target service is a service whose quantity of service execution times is not less than a preset quantity of times, and a difference between whose service execution moment and a preset service execution moment is not greater than preset duration in a statistical period.

The second generation unit is configured to generate the scenario service file based on the device service information of the second target service.

In another optional embodiment, the device service information further includes an identity of a first user.

The second generation unit is configured to determine, according to the identity of the first user, device service information of a third target service in the device service information of the second target service, where the third target service is a service that is in the second target service and is executed by the first user; and generate the scenario service file based on the device service information of the third target service.

In another optional embodiment, the second obtaining module 603 is configured to obtain a command sent by the terminal.

The processing module 602 is further configured to: determine that the scenario information satisfies the preset condition when the command sent by the terminal is a command used to execute the scenario service file.

In another optional embodiment, the second obtaining module 603 is configured to obtain a scenario moment of the scenario; and the processing module 602 is further configured to determine that the scenario information satisfies the preset condition when the cloud server detects that the scenario moment is a preset scenario moment.

In another optional embodiment, the second obtaining module 603 is configured to obtain a service attribute value sent by the smart home device; and the processing module 602 is further configured to determine that the scenario information satisfies the preset condition when the cloud server detects that the service attribute value is within a preset attribute value range.

In another optional embodiment, the processing module 602 is further configured to: after the processing module 602 generates the scenario service file based on the historical device service information, add device service information to the scenario service file according to an add command sent by the terminal; delete device service information from the scenario service file according to a delete command sent by the terminal; or modify device service information in the scenario service file according to a modify command sent by the terminal.

In another optional embodiment, the sending module 604 is further configured to send the scenario service file to the terminal, so that the scenario service file is displayed on a scenario page of the terminal; the second obtaining module 603 is further configured to receive a select command sent by the terminal; the processing module 602 is further configured to determine, according to the select command, device service information of a fourth target service in the scenario service file, and obtain associated service information corresponding to the fourth target service; and the sending module 604 is further configured to send the associated service information to the terminal, so that the associated service information is displayed on a scenario interface of the terminal.

In another optional embodiment, the processing module 602 is further configured to determine a first subscription service based on a scenario name in the scenario service file; and the sending module 604 is further configured to send the first subscription service to the terminal.

In another optional embodiment, the processing module 602 is further configured to determine a second subscription service based on the device service information in the scenario service file; and the sending module 604 is further configured to send the second subscription service to the terminal.

In another optional embodiment, the second obtaining module 603 is further configured to receive a sharing command sent by the first terminal, where the sharing command includes an identity of a second user and an IP address of a second terminal, and the second terminal is a terminal used by the second user; the processing module 602 is further configured to determine permission of the second user based on the identity information of the second user; and determine device service information of a fifth target service in the scenario service file based on permission of the second user; and the sending module 604 is further configured to send the device service information of the fifth target service to the second terminal based on the IP address of the second terminal.

This application provides a computer-readable storage medium, including an instruction. When the instruction is run on a computer, the computer is enabled to perform the method in any one of the foregoing embodiments.

All or some of the foregoing embodiments may be implemented by using software, hardware, firmware, or any combination thereof. When software is used to implement the embodiments, the embodiments may be implemented completely or partially in a form of a computer program product.

The computer program product includes one or more computer instructions. When the computer program instructions are loaded and executed on the computer, the procedure or functions according to the embodiments of the present disclosure are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (e.g., a coaxial cable, an optical fiber, or a digital subscriber line (DSL)) or wireless (e.g., infrared, radio, or microwave) manner. The computer-readable storage medium may be any usable medium accessible by a computer, or a data storage device, such as a server or a data center, integrating one or more usable media. The usable medium may be a magnetic medium (e.g., a floppy disk, a hard disk, or a magnetic tape), an optical medium (e.g., a DVD), a semiconductor medium (e.g., a solid-state drive (SSD)), or the like.

The foregoing embodiments are merely intended to describe the technical solutions of this application, rather than limit this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of this application.

1. A device service control method, comprising:
obtaining, by a cloud server, historical device service information of a plurality of smart home devices in a scenario, wherein device service information in the historical device service information comprises a service command and service attribute information, and the service attribute information comprises service execution moments;
generating, by the cloud server, a scenario service file based on the historical device service information, and sorting device service information in the scenario service file based on the service execution moments;
obtaining, by the cloud server, scenario information of the scenario; and
sending, by the cloud server, the service command in the scenario service file to the plurality of smart home devices when the scenario information satisfies a preset condition, so that the plurality of smart home devices execute a service according to the service command in the scenario service file.

2. The method according to claim 1, wherein the generating, by the cloud server, the scenario service file based on the historical device service information comprises:
determining, by the cloud server, a recording period according to a recording start command and a recording stop command that are sent by a terminal at different moments; and
generating, by the cloud server, the scenario service file based on the historical device service information sent by the plurality of smart home devices in the recording period.

3. The method according to claim 2, wherein the device service information further comprises an identity of a first user; and
the generating, by the cloud server, the scenario service file based on the historical device service information sent by the plurality of smart home devices in the recording period comprises:
determining, by the cloud server based on the identity of the first user, device service information of a first target service in the historical device service information sent in the recording period, wherein the first target service is a service executed by the first user in the recording period; and
generating, by the cloud server, the scenario service file based on the device service information of the first target service.

4. The method according to claim 1, wherein the generating, by the cloud server, the scenario service file based on the historical device service information comprises:
collecting, by the cloud server, statistics on the historical device service information to obtain a quantity of service execution times and a service execution moment of each service;
selecting, by the cloud server, device service information of a second target service from the historical device service information based on a statistical result, wherein the second target service is a service wherein a quantity of service execution times of the service is not less than a preset quantity of times, and a difference between a service execution moment of the service and a preset service execution moment is not greater than a preset duration in a statistical period; and
generating, by the cloud server, the scenario service file based on the device service information of the second target service.

5. The method according to claim 4, wherein the device service information further comprises an identity of a first user; and
the generating, by the cloud server, the scenario service file based on the device service information of the second target service comprises:
determining, by the cloud server, device service information of a third target service in the device service information of the second target service based on the identity of the first user, wherein the third target service is a function that is in the second target service and is executed by the first user; and
generating, by the cloud server, the scenario service file based on the device service information of the third target service.

6. The method according to claim 1, wherein
the obtaining, by the cloud server, the scenario information of the scenario comprises: obtaining, by the cloud server, a command sent by a terminal; and
the method further comprises: determining, by the cloud server, that the scenario information satisfies the preset condition when the command sent by the terminal is a command used to execute the scenario service file.

7. The method according to claim 1, wherein
the obtaining, by the cloud server, scenario information of the scenario comprises: obtaining, by the cloud server, a scenario moment of the scenario; and
the method further comprises: determining, by the cloud server, that the scenario information satisfies the preset condition when the cloud server detects that the scenario moment is a preset scenario moment.

8. The method according to claim 1, wherein
the obtaining, by the cloud server, scenario information of the scenario comprises: obtaining, by the cloud server, a service attribute value sent by a particular smart home device; and
the method further comprises: determining, by the cloud server, that the scenario information satisfies the preset condition when the cloud server detects that the service attribute value is in a preset attribute value range.

9. The method according to claim 1, wherein after the generating, by the cloud server, the scenario service file based on the historical device service information, the method further comprises:
adding, by the cloud server, device service information to the scenario service file according to an add command sent by the terminal;
deleting, by the cloud server, device service information from the scenario service file according to a delete command sent by the terminal; or
modifying, by the cloud server, device service information in the scenario service file according to a modify command sent by the terminal.

10. The method according to claim 1, wherein after the generating, by the cloud server, the scenario service file based on the historical device service information, the method further comprises:
sending, by the cloud server, the scenario service file to the terminal, wherein the scenario service file is displayed on a scenario page of the terminal;
receiving, by the cloud server, a select command sent by the terminal;
determining, by the cloud server, device service information of a fourth target service in the scenario service file according to the select command; and
obtaining, by the cloud server, associated service information corresponding to the fourth target service, and sending the associated service information to the terminal, wherein the associated service information is displayed on a scenario interface of the terminal.

11. A cloud server, comprising a processor and a memory;
wherein the memory is configured to store computer executable instructions, and the processor is configured to execute the computer executable instructions that cause the processor to:
obtain historical device service information from a plurality of smart home devices in a scenario, wherein device service information in the historical device service information comprises a service command and service attribute information, and the service attribute information comprises service execution moments;
generate a scenario service file based on the historical device service information, and sort device service information in the scenario service file based on the service execution moments;
obtain scenario information of the scenario; and
send the service commands in the scenario service file to the plurality of smart home devices when the scenario information satisfies a preset condition, so that the plurality of smart home devices execute a service according to the service command in the scenario service file.

12. The cloud server according to claim 11, wherein the processor is further configured to:
determine a recording period according to a recording start command and a recording stop command that are sent by a terminal at different moments; and
generate the scenario service file based on the historical device service information sent by the plurality of smart home devices in the recording period.

13. The cloud server according to claim 12, wherein the device service information further comprises an identity of a first user; and
the processor is further configured to:
determine, based on the identity of the first user, device service information of a first target service in the historical device service information sent in the recording period, wherein the first target service is a service executed by the first user in the recording period; and
generate the scenario service file based on the device service information of the first target service.

14. The cloud server according to claim 11, wherein the processor is further configured to:
collect statistics on the historical device service information to obtain a quantity of service execution times and a service execution moment of each service;
select device service information of a second target service from the historical device service information based on a statistical result, wherein the second target service is a service wherein a quantity of service execution times of the service is not less than a preset quantity of times, and a difference between a service execution moment of the service and a preset service execution moment is not greater than preset duration in a statistical period; and
generate the scenario service file based on the device service information of the second target service.

15. The cloud server according to claim 14, wherein the device service information further comprises an identity of a first user; and
the processor is configured to determine device service information of a third target service in the device service information of the second target service based on the identity of the first user, wherein the third target service is a function that is in the second target service and is executed by the first user.

16. The cloud server according to claim 11, wherein:
the processor is configured to obtain a command sent by a terminal; and
the processor is further configured to: determine that the scenario information satisfies the preset condition when the command sent by the terminal is a command used to execute the scenario service file.

17. The cloud server according to claim 11, wherein:
the processor is configured to obtain a scenario moment of the scenario; and
the processor is further configured to, determine that the scenario information satisfies the preset condition when the processing module detects that the scenario moment is a preset scenario moment.

18. The cloud server according to claim 11, wherein:
the processor is configured to obtain a service attribute value sent by a particular smart home device; and
the processor is further configured to determine that the scenario information satisfies the preset condition when the processing module detects that the service attribute value is in a preset attribute value range.

19. The cloud server according to claim 11, wherein:
the processor is further configured to: after the processing module generates the scenario service file based on the historical device service information, add device service information to the scenario service file according to an add command sent by the terminal; delete device service information from the scenario service file according to a delete command sent by the terminal; or modify device service information in the scenario service file according to a modify command sent by the terminal.

20. A smart home system, comprising:
a cloud server and a plurality of smart home devices, wherein:
the cloud server is configured to obtain historical device service information from a plurality of smart home devices in a scenario, wherein device service information in the historical device service information comprises a service command and service attribute information, and the service attribute information comprises service execution moments; generate a scenario service file based on the historical device service information, and sort device service information in the scenario service file based on the service execution moments; obtain scenario information of the scenario; and send the service commands in the scenario service file to the plurality of smart home devices when the scenario information satisfies a preset condition; and
each smart home device is configured to send corresponding device service information to the cloud server, receive a service command that is in the scenario service file and that is sent by the cloud server, and execute a service according to the service command in the scenario service file.
